(19) United States
(12) Patent Application Publication
(10) Pub. No.: US 2018/0269740 A1
(43) Pub. Date: Sep. 20, 2018

(54) INSTALLATION SYSTEM OF INVERTER WIRES AND MOTOR WIRES AND RELATED METHOD

(71) Applicant: Shanghai XPT Technology Limited, Shanghai City (CN)

(72) Inventors: Zhaofeng Li, Gongyi City (CN); Jifei Ma, Tianmen City (CN); Kangjun Luo, Zhongshan City (CN); Miao Luo, Zhongshan City (CN); Bohan Yang, Hanzhong City (CN)

(21) Appl. No.: 15/710,841

(22) Filed: Sep. 21, 2017

(30) Foreign Application Priority Data
Mar. 15, 2017 (CN) 201710154111.1
Mar. 15, 2017 (CN) 201720251541.0

(51) Int. Cl. H02K 3/04; H02K 11/20; H02K 11/30; H02K 15/00

(52) U.S. Cl. CPC H02K 3/04; H02K 15/00; H02K 11/30; H02K 11/20

(57) ABSTRACT

An installation system of inverter wires and motor wires includes a plurality of positioning modules, a driving device and a control unit. Each positioning module includes a positioning unit and a pressure sensor. The positioning unit corresponds to a fixing hole of a motor wire of a motor. The pressure sensor is arranged on the positioning unit and configured to sense a pressure applied from an inverter wire of an inverter. The driving device is configured to drive the positioning unit to penetrate through or away from the fixing hole of the motor wire according to whether a pressure applied from the inverter wire is greater than a predetermined value, such that a fixing hole of the inverter wire is able to be aligned with the fixing hole of the motor wire and the fixing hole of the junction block.

### BACKGROUND OF THE INVENTION

### 1. Field of the Invention

The present invention relates to an installation system of inverter wires and motor wires and a method thereof, and more particularly, to an installation system and method capable of installing inverter wires and motor wires with high efficiency and high quality.

### 2. Description of the Prior Art

A drive system powered by electricity (such as the drive system of an electric car or a hybrid car) usually uses an AC motor as a power output source, due to its low cost, simple structure, ease of maintenance and high efficiency. A battery pack of the electric or hybrid car is usually a DC battery pack, and therefore requires an inverter arranged between the battery pack and the AC motor configured to switch from DC current to AC current for driving the AC motor. Wires of the AC motor are rigid wires, and wires of the inverter are soft wires. The wire installation method according to the prior art manually aligns a fixing hole of the AC motor wire (soft wire) and a fixing hole of a junction block, then moves the inverter in order to move the inverter wire (rigid wire) along the AC motor wire, such that a fixing hole of the inverter wire is aligned with the fixing hole of the AC motor wire and the fixing hole of the junction block. A fastening member is configured to fix the inverter wire and the AC motor wire on the junction block through the fixing holes. Since the AC motor wire is soft, shape and dimension of the AC motor wire are not fixed. Therefore, manual installation of the wires is inefficient and difficult to operate, making it hard to maintain the installation quality.

### SUMMARY OF THE INVENTION

An objective of the present invention is to provide an installation system capable of installing inverter wires and motor wires with high efficiency and high quality.

According to an embodiment of the present invention, an installation system of inverter wires and motor wires comprises a plurality of positioning modules, a driving device and a control unit. Each positioning module comprises a positioning unit and a pressure sensor. The positioning unit corresponds to a fixing hole of a motor wire of a motor. The pressure sensor is arranged on the positioning unit and configured to sense pressure applied from an inverter wire of an inverter. The driving device is configured to drive the positioning unit to penetrate through or away from the fixing hole of the motor wire. The control unit is electrically connected to the pressure sensor and the driving device. When the fixing hole of the motor wire is aligned with a fixing hole of a junction block, the control unit is configured to control the driving device to drive the positioning unit to penetrate the fixing hole of the motor wire and the fixing hole of the junction block. When the pressure sensor senses the pressure applied from the inverter wire is greater than a predetermined value, the control unit is configured to control the driving device to drive the positioning unit to move away from the fixing hole of the motor wire and the fixing hole of the junction block, such that a fixing hole of the inverter wire is able to be aligned with the fixing hole of the motor wire and the fixing hole of the junction block.

According to another embodiment of the present invention, an installation method of inverter wires and motor wires comprises providing an installation system of inverter wires and motor wires, wherein the installation system comprises a plurality of positioning modules. Each positioning module comprises a positioning unit and a pressure sensor, wherein the positioning unit corresponds to a fixing hole of the motor wire of a motor, and the pressure sensor is arranged on the positioning unit. When the fixing hole of the motor wire is aligned with a fixing hole of a junction block, the positioning unit is driven to penetrate the fixing hole of the motor wire and the fixing hole of the junction block. An inverter is moved toward the pressure sensor, and the pressure sensor senses a pressure applied from an inverter wire of the inverter. When the pressure sensor senses the pressure applied from an inverter wire of the inverter is greater than a predetermined value, the positioning unit is driven to move away from the fixing hole of the motor wire and the fixing hole of the junction block. The inverter is moved a predetermined distance, such that a fixing hole of the inverter wire is able to be aligned with the fixing hole of the motor wire and the fixing hole of the junction block. A fastening member is provided to fix the inverter wire and the motor wire on the junction block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an installation system of inverter wires and motor wires of the present invention.

FIG. 2 is an exploded view of an inverter and a motor before installation.

FIG. 3 is a diagram showing a step of an installation process of an inverter wire and a motor wire by the installation system of the present invention.

FIG. 4 is a diagram showing another step of the installation process of the inverter wire and the motor wire by the installation system of the present invention.

FIG. 5 is a diagram showing another step of the installation process of the inverter wire and the motor wire by the installation system of the present invention.

FIG. 6 is a diagram showing another step of the installation process of the inverter wire and the motor wire by the installation system of the present invention.

FIG. 7 is a flowchart showing the installation method of the inverter wires and motor wires of the present invention.

### DETAILED DESCRIPTION

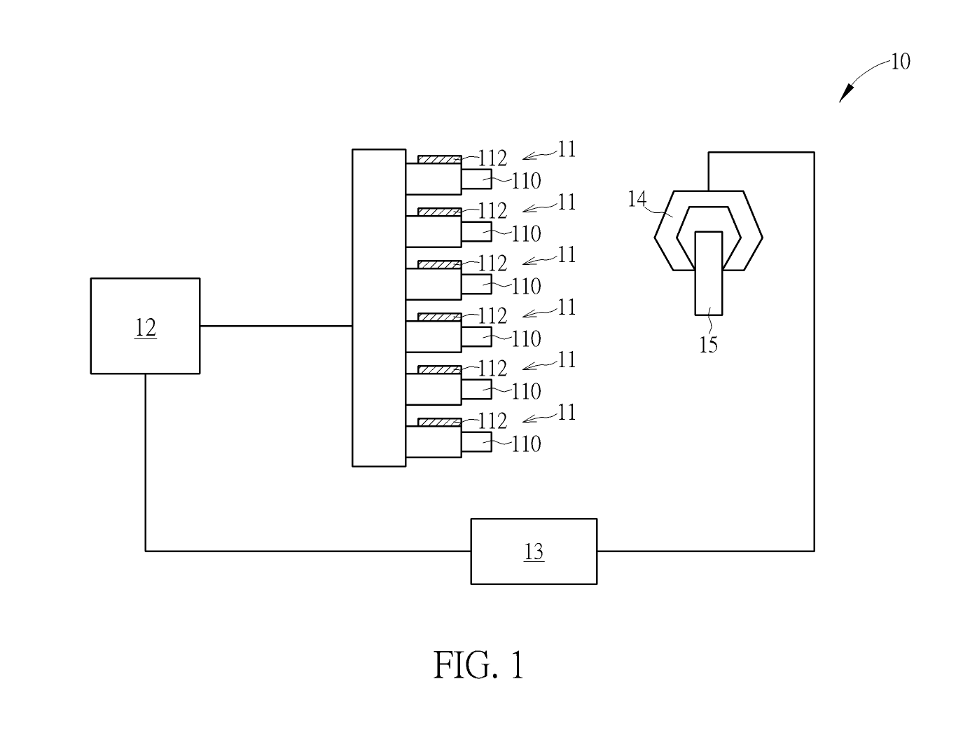

Please refer to FIG. 1, which is a diagram showing an installation system of inverter wires and motor wires according to the present invention. As shown in FIG. 1, an installation system 10 of inverter wires and motor wires comprises a plurality of positioning modules 11, a driving device 12 and a control unit 13. Each positioning module comprises a positioning unit 110 and a pressure sensor 112. A front end of the positioning unit 110 can be made of an elastic material. The pressure sensor 112 is arranged on the positioning unit 110. The driving device 12 is connected to the positioning modules 11 and configured to drive the positioning modules 11 to move. The control unit 13 is electrically connected to the pressure sensor 112 and the driving device 12 and configured to control the driving device 12 according to a pressure value sensed by the pressure sensor 112. Preferably, the installation system 10 further comprises a holding device 14 electrically connected to the control unit 13. The holding device 14 is configured to hold and move an inverter 15. In the present embodiment, the installation system 10 has six positioning modules 11, but the present invention is not limited thereto. The quantity of the positioning modules can be arranged corresponding to the quantity of wires of the inverter.

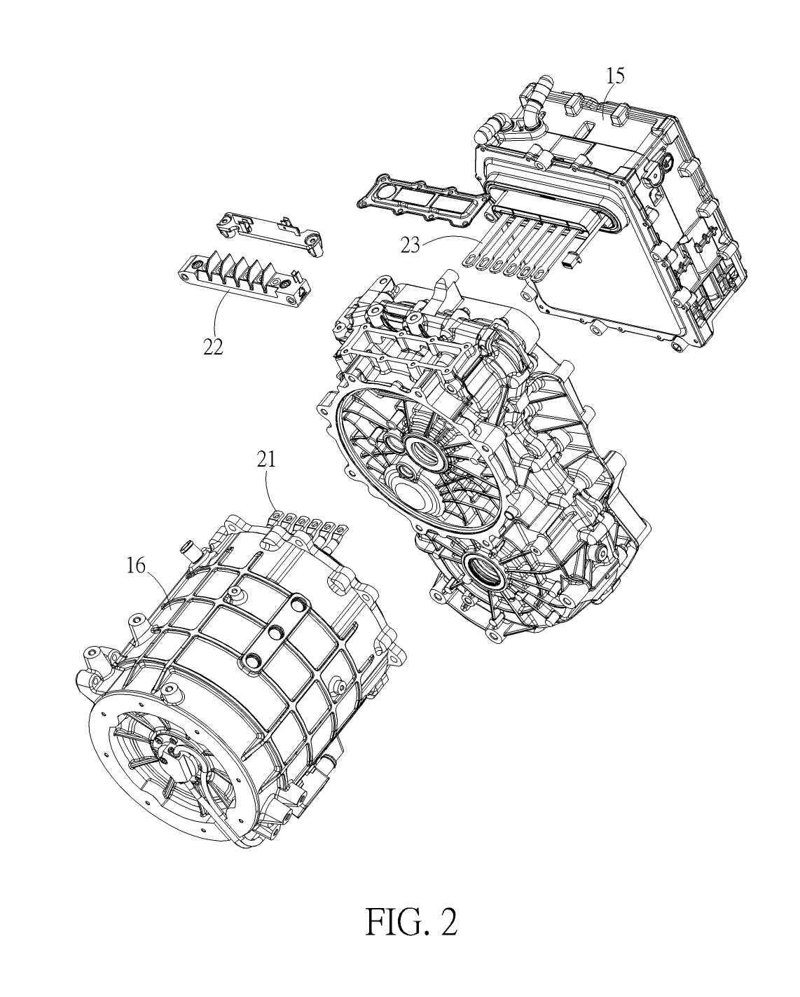

Please refer to FIG. 2. FIG. 2 is an exploded view of an inverter and a motor before installation. As shown in FIG. 2, the inverter 15 has a plurality of inverter wires 23. The motor 16 has a plurality of motor wires 21. A junction block 22 has a plurality of fixing holes corresponding to the quantity of inverter wires 23 and motor wires 21. The fixing holes are configured to be penetrated by a fastening member to fix the inverter wires 23 and the motor wires 21. In the present embodiment, the installation system 10 has six positioning modules 11 corresponding to the six inverter wires 23 and the six motor wires 21, but the present invention is not limited thereto.

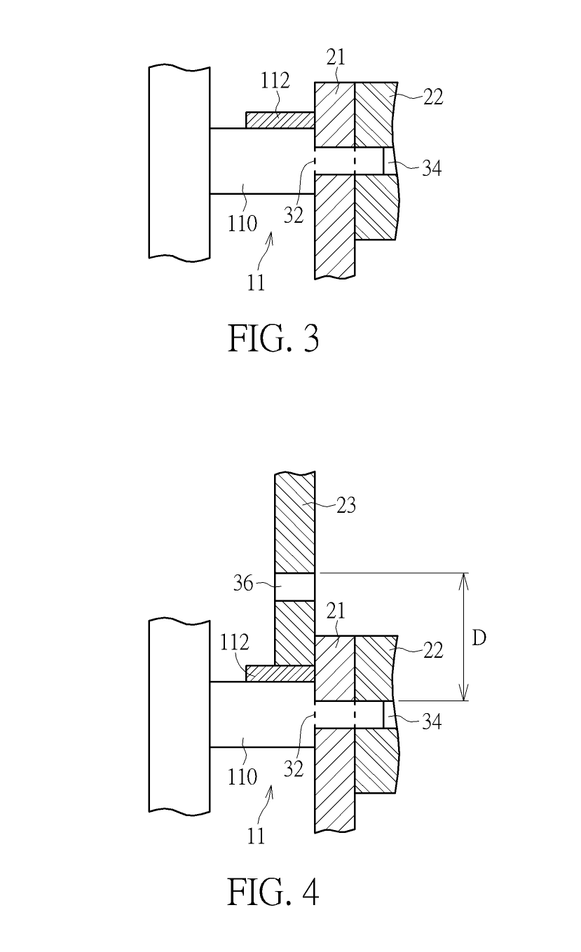

Please refer to FIGS. 3 to 6, as well as FIGS. 1 and 2. FIG. 3 to FIG. 6 are diagrams showing steps of an installation process of an inverter wire and a motor wire by the installation system of the present invention. As shown in FIG. 3, when a fixing hole 32 of the motor wires 21 is aligned with a fixing hole 34 of the junction block 22, the control unit 13 is configured to control the driving device to drive the positioning modules 11 to move, such that the positioning unit 110 of the positioning modules 11 penetrates the fixing hole 32 of the motor wires 21 and the fixing hole 34 of the junction block 22, in order to hold the aligned status of the fixing hole 32 of the motor wires 21 and the fixing hole 34 of the junction block 22. As shown in FIG. 4, after the fixing hole 32 of the motor wires 21 is aligned with the fixing hole 34 of the junction block 22, the control unit 13 is able to control the holding device 14 to hold and move the inverter 15, such that the inverter wire 23 is moved to abut and apply pressure to the pressure sensor 112.

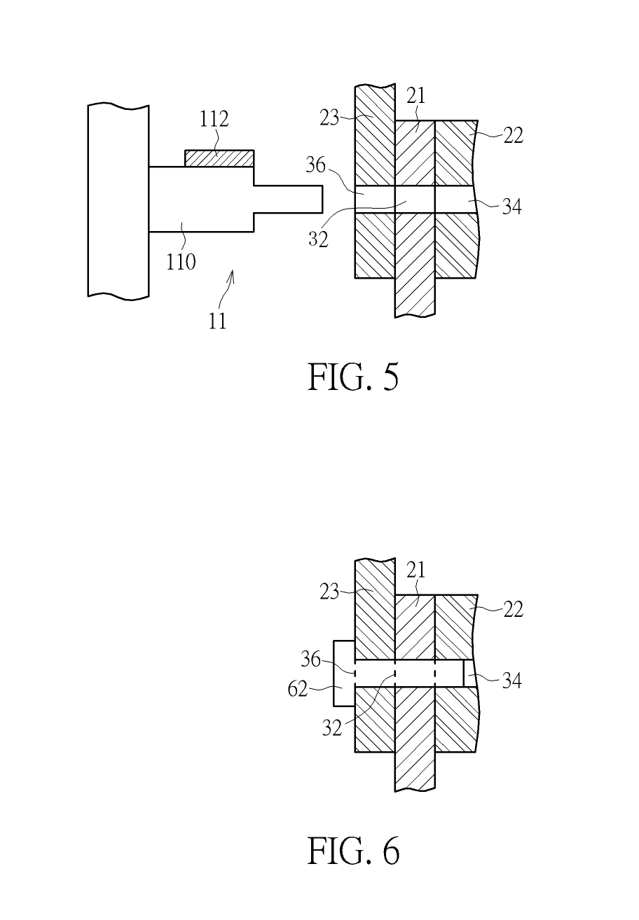

As shown in FIG. 5, when the pressure sensor 112 senses the pressure applied from the inverter wire 23 is greater than a predetermined value, the control unit 13 is configured to control the driving device 12 to drive the positioning unit 110 to move away from the fixing hole 32 of the motor wires 21 and the fixing hole 34 of the junction block 22, such that the holding device 14 is able to continually move the inverter 15. Since the inverter wire 23 is a rigid wire, after the positioning unit 110 is moved away from the fixing hole 32 of the motor wires 21 and the fixing hole 34 of the junction block 22, the inverter wire 23 and the junction block 22 are able to grip the motor wires 21 to hold the motor wires 21 in position in order to keep the fixing hole 32 of the motor wires 21 aligned with the fixing hole 34 of the junction block 22. When the inverter wire 23 abuts the pressure sensor 112, a predetermined distance D (as shown in FIG. 4) between a fixing hole 36 of the inverter wire 23 and the fixing hole 34 of the junction block 22 is observed. When the positioning unit 110 is moved away from the fixing hole 32 of the motor wires 21 and the fixing hole 34 of the junction block 22, the control unit 13 is able to control the holding device 14 to further move the inverter 15 the predetermined distance D, such that the fixing hole 36 of the inverter wire 23 is aligned with the fixing hole 32 of the motor wires 21 and the fixing hole 34 of the junction block 22.

As shown in FIG. 6, after the fixing hole 36 of the inverter wire 23 is aligned with the fixing hole 32 of the motor wires 21 and the fixing hole 34 of the junction block 22, a fastening member 62 is configured to fix the inverter wire 23 and the motor wires 21 on the junction block 22. For simplification, FIG. 3 to FIG. 6 show the installation processes of one of the plurality of positioning modules 11; however, all the positioning modules 11 are able to be in the installation process at the same time.

When the plurality of pressure sensors 112 of the installation system 10 senses the difference in pressure values from the different inverter wires 23 is greater than an allowable value, the control unit 13 is configured to control the holding device 14 to move the inverter 15 away from the pressure sensors 112. For example, when the holding device 14 inappropriately grips the inverter 15 or when the inverter 15 is tilted, the pressure values sensed by the pressure sensors 112 from the different inverter wires 23 are different. In such a circumstance, the control unit 13 is able to control the holding device 14 to move the inverter 15 away from the pressure sensors 112 to prevent the installation process from error, thereby enabling the installation system 10 to be calibrated.

According to the above arrangement, the positioning unit 110 of the installation system 10 of the present invention is configured to penetrate the fixing hole 32 of the motor wires 21 and the fixing hole 34 of the junction block 22 for keeping the fixing hole 32 aligned with the fixing hole 34. After the fixing hole 32 of the motor wires 21 is aligned with the fixing hole 34 of the junction block 22, the positioning unit 110 is moved away from the fixing hole 34, such that the inverter wires 23 (rigid wire) are able to grip the motor wires 21 (soft wire), and can further move the fixing hole 36 of the inverter wire 23 to align with the fixing hole 32 of the motor wires 21 and the fixing hole 34 of the junction block 22. As such, the influence of uncertainty of shape and dimension of the motor wire is reduced, while efficiency and quality of the installation of the motor wire and inverter wire are improved.

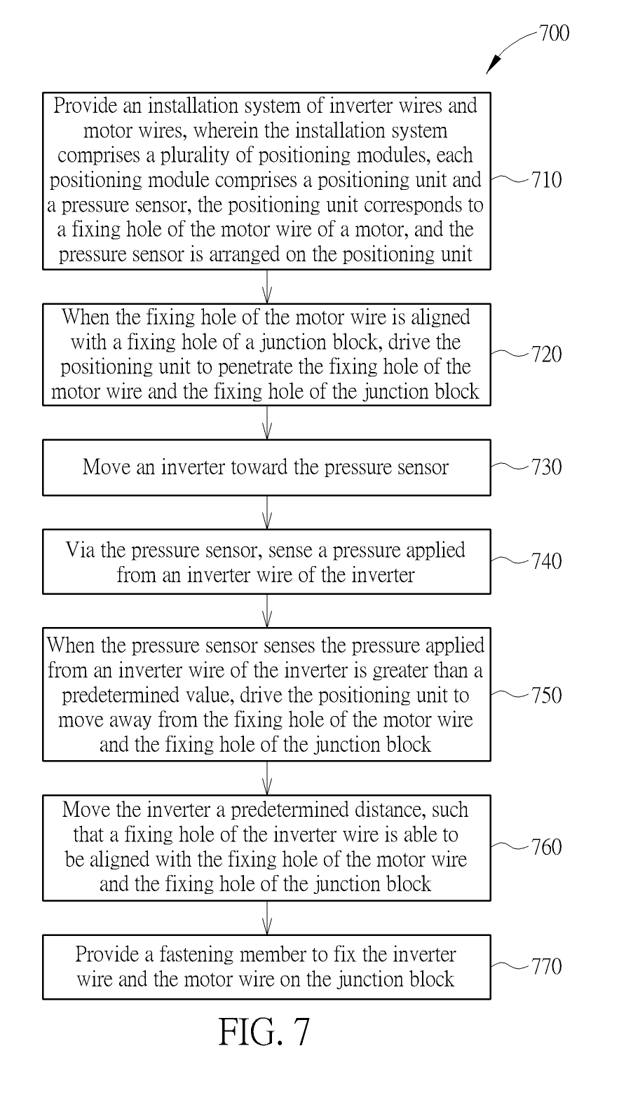

Please refer to FIG. 7. FIG. 7 is a flowchart 700 showing the installation method of inverter wires and motor wires of the present invention. The installation method of the present invention comprises the following steps:

Step 710: Provide an installation system of inverter wires and motor wires, wherein the installation system comprises a plurality of positioning modules, each positioning module comprises a positioning unit and a pressure sensor, the positioning unit corresponds to a fixing hole of the motor wire of a motor, and the pressure sensor is arranged on the positioning unit;

Step 720: When the fixing hole of the motor wire is aligned with a fixing hole of a junction block, drive the positioning unit to penetrate the fixing hole of the motor wire and the fixing hole of the junction block;

Step 730: Move an inverter toward the pressure sensor;

Step 740: Via the pressure sensor, sense a pressure applied from an inverter wire of the inverter;

Step 750: When the pressure sensor senses the pressure applied from an inverter wire of the inverter is greater than a predetermined value, drive the positioning unit to move away from the fixing hole of the motor wire and the fixing hole of the junction block;

Step 760: Move the inverter a predetermined distance, such that a fixing hole of the inverter wire is able to be aligned with the fixing hole of the motor wire and the fixing hole of the junction block; and

Step 770: Provide a fastening member to fix the inverter wire and the motor wire on the junction block.

In contrast to the prior art, the disclosed installation system of inverter wires and motor wires is able to grip the motor wires by the junction block and the inverter wires in order to make the fixing holes of the inverter wires align with the fixing holes of the motor wires. The influence of the uncertainty of shape and dimension of the motor wire can thereby be reduced. Moreover, the quantity of positioning modules is arranged corresponding to the quantity of inverter wires and motor wires, allowing all positioning modules to be in the installation process at the same time. As a result, the installation system of the present invention is capable of improving efficiency and quality of installation, such that manual installation can be replaced by the installation system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An installation system of inverter wires and motor wires, comprising:
a plurality of positioning modules, each positioning module comprising:
a positioning unit corresponding to a fixing hole of a motor wire of a motor; and
a pressure sensor arranged on the positioning unit, and configured to sense a pressure applied from an inverter wire of an inverter;
a driving device configured to drive the positioning unit to penetrate through or away from the fixing hole of the motor wire; and
a control unit electrically connected to the pressure sensor and the driving device, wherein when the fixing hole of the motor wire is aligned with a fixing hole of a junction block, the control unit is configured to control the driving device to drive the positioning unit to penetrate through the fixing hole of the motor wire and the fixing hole of the junction block, and when the pressure sensor senses the pressure applied from the inverter wire is greater than a predetermined value, the control unit is configured to control the driving device to drive the positioning unit to move away from the fixing hole of the motor wire and the fixing hole of the junction block, such that a fixing hole of the inverter wire is able to be aligned with the fixing hole of the motor wire and the fixing hole of the junction block.

2. The installation system of claim 1, further comprising a holding device electrically connected to the control unit and configured to hold and move the inverter, wherein when the positioning unit penetrates through the fixing hole of the motor wire and the fixing hole of the junction block, the control unit is configured to control the holding device to move the inverter toward the pressure sensor, and when the pressure sensor senses the pressure applied from the inverter wire is greater than the predetermined value, the control unit is configured to control the holding device to move the inverter a predetermined distance, such that the fixing hole of the inverter wire is able to be aligned with the fixing hole of the motor wire and the fixing hole of the junction block.

3. The installation system of claim 2, wherein when the plurality of pressure sensors senses the difference of the pressure values from the different inverter wires is greater than an allowable value, the control unit is configured to control the holding device to move the inverter away from the plurality of pressure sensors.

4. The installation system of claim 1, wherein the positioning unit is made of an elastic material.

5. An installation method of inverter wires and motor wires, comprising:
providing an installation system of inverter wires and motor wires, wherein the installation system comprises a plurality of positioning modules, each positioning module comprises a positioning unit and a pressure sensor, the positioning unit corresponds to a fixing hole of the motor wire of a motor, and the pressure sensor is arranged on the positioning unit;
when the fixing hole of the motor wire is aligned with a fixing hole of a junction block, driving the positioning unit to penetrate through the fixing hole of the motor wire and the fixing hole of the junction block;
moving an inverter toward the pressure sensor;
via the pressure sensor, sensing a pressure applied from an inverter wire of the inverter;
when the pressure sensor senses the pressure applied from an inverter wire of the inverter is greater than a predetermined value, driving the positioning unit to move away from the fixing hole of the motor wire and the fixing hole of the junction block;
moving the inverter a predetermined distance, such that a fixing hole of the inverter wire is able to be aligned with the fixing hole of the motor wire and the fixing hole of the junction block; and
providing a fastening member to fix the inverter wire and the motor wire on the junction block.

6. The installation method of claim 5, further comprising:
when the plurality of pressure sensors sense the difference of the pressure values between the different inverter wires is greater than an allowable value, moving the inverter away from the plurality of pressure sensors.
